(19) United States
(12) Patent Application Publication
(10) Pub. No.: US 2026/0226227 A1
(43) Pub. Date: Aug. 6, 2026

(54) A METHOD FOR OBTAINING WATER-SOLUBLE N-TYPE CONDUCTING POLYMER

(71) Applicant: WESTRA MATERIALS AB, Norrköping (SE)

(72) Inventors: Qifan Li, Norrköping (SE); Jun-Da Huang, Norrköping (SE); Chi-Yuan Yang, Norrköping (SE); Simone Fabiano, Norrköping (SE)

(73) Assignee: WESTRA MATERIALS AB, Norrköping (SE)

(21) Appl. No.: 19/149,348

(22) PCT Filed: Feb. 10, 2023
(86) PCT No.: PCT/EP2023/053385

§ 371 Date: Jul. 18, 2025

(51) Int. Cl. C08G 61/12; H01B 1/12

(52) U.S. Cl. CPC C08G 61/125; H01B 1/128; C08G 2261/3242; C08G 2261/334; C08G 2261/43; C08G 2261/514

(57) ABSTRACT

The present invention relates to a method for manufacturing a water-soluble n-type conducting polymer, the method comprising the steps of: a) adding a monomer to a solvent system comprising water in the presence of a catalyst, thus providing a reaction solution; b) allowing the monomer to polymerize in the reaction solution thus obtaining an n-type conducting polymer solution; c) post-treating the n-type conducting polymer solution thus obtaining a water-soluble n-type conducting polymer.

### TECHNICAL FIELD

The present invention relates to a method for manufacturing a water-soluble n-type conducting polymer, a water-soluble n-type conducting polymer obtained by such a method, and a water-based ink comprising the water-soluble n-type conducting polymer obtained by such a method.

### BACKGROUND OF THE INVENTION

Water-based conducting polymer inks have broad industrial applications, such as antistatic coatings, polymer capacitors, organic solar cells, displays (LCD/OLED), and printed electronics. PEDOT:PSS is a commercially available p-type (hole-transporting) water-based conducting polymer ink with a pristine electrical conductivity>1 S cm⁻¹, reaching values>4000 S cm⁻¹ after secondary doping or post-treating. However, water-based n-type (electron-transporting) conducting polymers are crucial when considering complementary components in semiconducting devices and circuitry.

The BBL: PEI ethanol-based inks reported in WO 2022/106017 and WO 2022/106018 are the first step towards environmentally friendly solvent n-type inks. However, there are several problems partially limiting their application. First of all, ethanol has strict requirements for fire prevention during production, transportation, storage, and usage. Further, the inks disclosed in the above-referenced applications are mainly limited to deposition methods such as spray-casting, spin-casting and the like due to the large particle size. As may be gleaned from the above-cited references, the highest electrical conductivity of BBL: PEI inks is below 10 S cm-1, which make them unsuitable for devices sensitive to sheet resistance.

Recently, Fei Huang et al. reported a solution-processed n-type conducting polymer poly(benzodifurandione) (PBFDO) with electrical conductivity over 2000 S cm⁻¹ (Nature, 2022, s41586-022-05295-8). PBFDO is polymerized and processed in dimethyl formamide (DMF) or dimethyl sulfoxide (DMSO), solvents that are hard to print in an industrial setting.

Developing a water-based n-type CP ink with high conductivity, processability, and stability equivalent to PEDOT:PSS remains a challenging scientific and industrial endeavour with widespread impact in low-cost printed organic electronics.

### SUMMARY OF THE INVENTION

Considering the above, the present invention aims to solve the problems of the prior art. To this end, the present invention relates to a method for manufacturing a water-soluble n-type conducting polymer, the method comprising the steps of:
a) adding a monomer to a solvent system comprising water in the presence of a catalyst, thus providing a reaction solution;
b) allowing the monomer to polymerize in the reaction solution thus obtaining an n-type conducting polymer solution;
c) post-treating the n-type conducting polymer solution thus obtaining a water-soluble n-type conducting polymer.

The monomer has the central symmetrical benzene ring as the skeleton, active hydrogen and at least one electron-withdrawing group at the benzylic position. The electron-withdrawing groups may be carbonyl, carboxyl, amide, alkoxy acyl or the like.

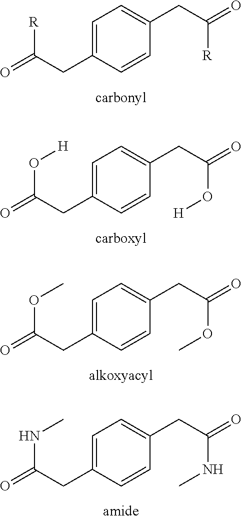

Further, the monomer may be in the form of a heterocyclic moiety having a central symmetrical benzene ring fused with at least one, preferably at least two rings, preferably five-membered rings. The monomer further comprises an active hydrogen and at least one electron-withdrawing group at the benzylic position. In particular, the monomer may be 3,7-dihydrobenzo[1,2-b:4,5-b′]difuran-2,6-dione (HBFDO), 5,7-dihydropyrrolo[2,3-f]indole-2,6(1H,3H)-dione, or 3,7-dihydrobenzo[1,2-b:4,5-b′]dithiophene-2,6-dione.

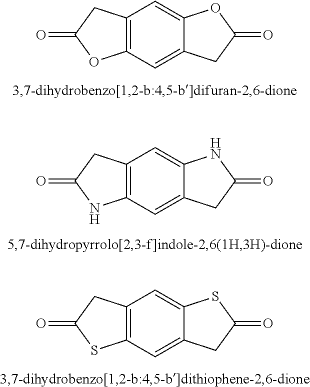 [SMILES: O=C1Cc2cc3c(cc2O1)CC(=O)O3 ; O=C1Cc2cc3c(cc2N1)CC(=O)N3 ; O=C1Cc2cc3c(cc2S1)CC(=O)S3]

In particular, the monomer is 3,7-dihydrobenzo[1,2-b:4,5-b′]difuran-2,6-dione (HBFDO). In such an embodiment, the n-type conducting polymer is poly(benzodifurandione) (PBFDO). The general overview of the method of the present invention may be summarized as follows:

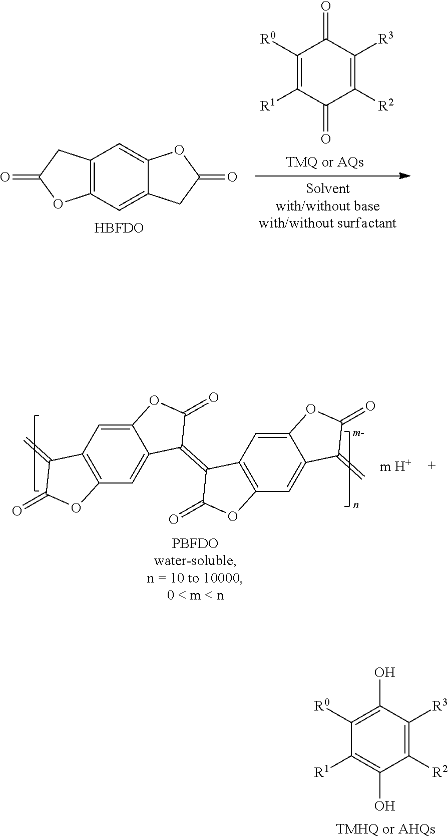

wherein TMQ or AQ is the catalyst, as depicted below.

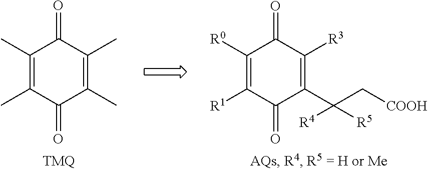

According to the first embodiment, the solvent system consists of water. In other words, the solvent system comprises substantially only water, e.g. at least 99 vol % water. Such an embodiment offers the advantage of a cost-efficient and environmentally friendly manufacturing method.

In an embodiment wherein the solvent system consists of water, the method further comprises a step of:
a′) adding a base to the reaction solution.

Step a′) may occur during or immediately after step a). In other words, the base may be added to the reaction solution together with the monomer and the catalyst, or immediately after the addition of the monomer and the catalyst.

Additionally, the method may further comprise a step of:
a″) adding a surfactant to the reaction solution.

Step a′) may occur during or immediately after step a). In other words, the surfactant may be added to the reaction solution together with the monomer and the catalyst, or immediately after the addition of the monomer and the catalyst. Further, step a″) may occur immediately before, immediately after, or simultaneously with step a′).

As may be understood from above, the surfactant is not essential for the method according to the first embodiment. However, the surfactant must be added if the polymer is intended to be used for spin-casting.

According to the first embodiment, the catalyst may be an alkyl- and carboxyl-substituted benzoquinone (AQ). Such a catalyst may be selected from the group consisting of 3-(2,4,5-trimethyl-3,6-dioxocyclohexa-1,4-dien-1-yl)propanoic acid (AMMMQ, R⁰=R¹=R³=Me), 3,3′-(4,5-dimethyl-3,6-dioxocyclohexa-1,4-diene-1,2-diyl)dipropionic acid (AAMMQ, R⁰=R¹=Me, R³=—CH₂R⁴R⁵COOH, R⁴, R⁵=H or Me), 3,3′-(2,5-dimethyl-3,6-dioxocyclohexa-1,4-diene-1,4-diyl)dipropionic acid (AMAMQ, R¹=R³=Me, R⁰=—CH₂R⁴R⁵COOH, R⁴, R⁵=H or Me) and combinations thereof.

The catalysts can be easily isolated, recovered, and recycled to further polymerize PBFDO, as shown in the scheme below.

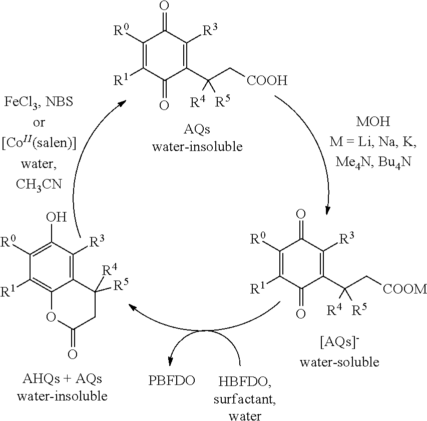

AQs can be synthesized by Michael addition followed by oxidation with N-bromosuccinimide (NBS), as is described in greater detail below. AQs are highly crystalline water-insoluble organic acids. However, when they are neutralized with strong bases, AQs will be converted into highly water-soluble [AQs]-. When the solvent system consists of water, [AQs] can catalyse the polymerization of water-insoluble HBFDO monomer into water-soluble PBFDO in presence of a surfactant. It is remarkable that after the polymerization, the aqueous solution becomes strongly acidic, and the [AQs] will be converted into water-insoluble AHQs and AQs, which can be separated from the PBFDO ink by simple suction filtration. The mix of AHQs and AQs can be converted into pure AQs by mild oxidation. Consequently, AQs are readily recyclable, thus offering the advantage of cost-efficiency and low environmental impact.

According to the first embodiment of the present invention, the base may be MOH, wherein M is selected from Li⁺, Na⁺, K⁺, Me₄N⁺, Bu₄N⁺ or combination thereof.

The surfactant may be selected from polyethylene glycol (PEG), polyvinylpyrrolidone (PVP), polyvinyl alcohol (PVA), sodium polystyrene sulfonate (PSSNa), poly(styrene sulfonate) acid (PSSH), sodium dodecylbenzenesulfonate (DBSNa), polyquaternium-4 (PQ-4), polyquaternium-10 (PQ-10), polydiallyldimethylammonium chloride (PDADMAC), polydiallyldiethylammonium chloride (PDADEAC), TWEEN® 20, TWEEN® 80, κ-Carrageenan, PEG-PPG-PEG, Polyoxyethylene (10) tridecyl ether, Triton™ X-100 or combination thereof.

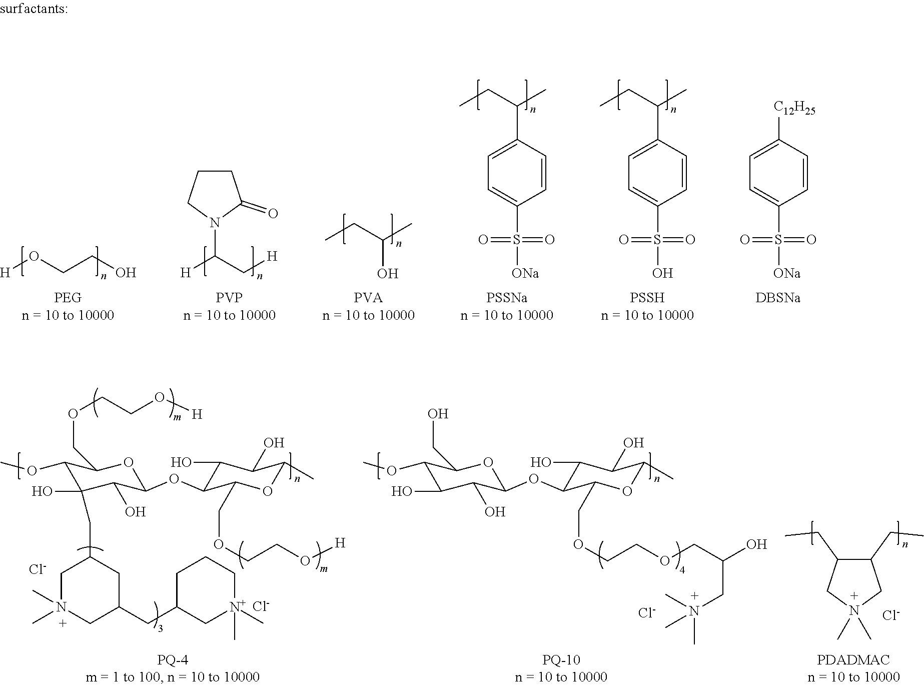

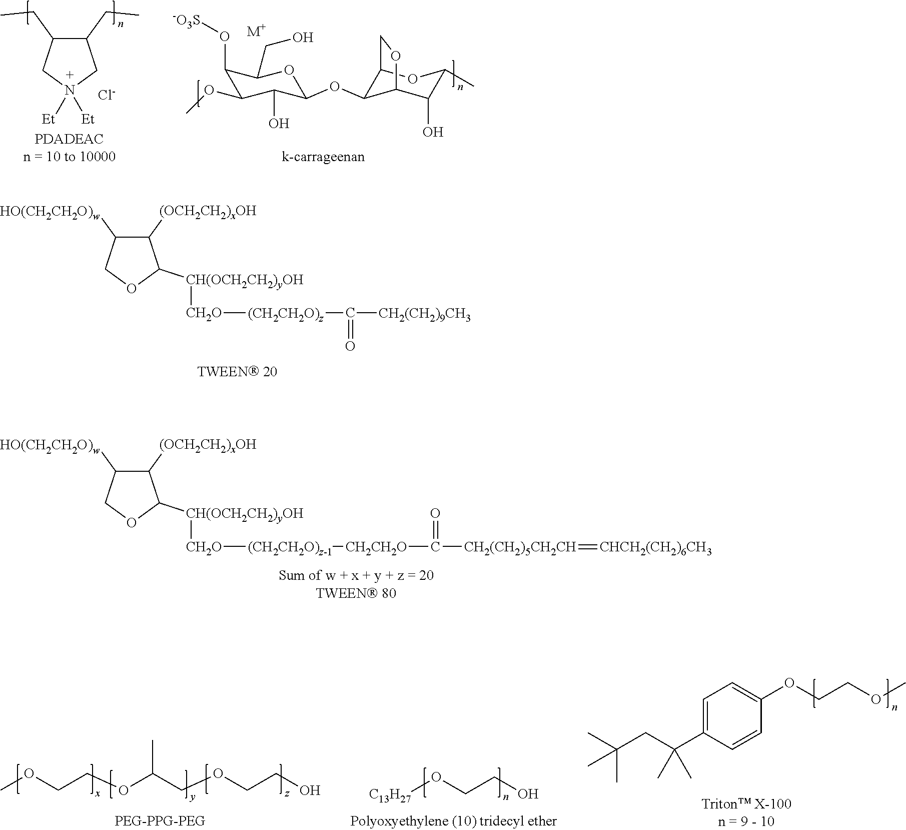

PBFDO dissolved in DMSO and obtained by using the polymerization method reported by Huang et al. precipitates after adding water to the DMSO solution. In other words, PBFDO polymerized in DMSO cannot be dissolved in water, even in the presence of surfactants such as polyethylene glycol (PEG). The inventors surprisingly found that performing the initial polymerization in water in the presence of AQs and a base promotes the formation of water-soluble PBFDO micelles, that are further stabilized by addition of a surfactant.

According to the second embodiment of the present invention, the solvent system may comprise a polar aprotic solvent. In such an embodiment, the method further comprises the step of:
d) solvent exchanging such that the polar aprotic solvent is removed.

The polar aprotic solvent may be dimethyl sulfoxide (DMSO), dimethyl formamide (DMF), dimethyl acetamide (DMA) or a combination thereof. The ratio between water and the polar aprotic solvent may be from 5:95 to 95:5, preferably from 40:60 to 60:40.

According to the second embodiment of the present invention, i.e, wherein the solvent system comprises a polar aprotic solvent, the catalyst may be a quinone oxidant selected from tetramethyl benzoquinone (TMQ), alkyl- and carboxyl-substituted benzoquinones (AQs), or combination thereof.

The inventors have surprisingly found that performing the polymerization reaction in a solvent system comprising water and a polar aprotic solvent promotes the formation of water-soluble PBFDO micelles, that may be further stabilized by addition of a surfactant, e.g. as disclosed above. It should be noted that according to the second embodiment of the present invention, the surfactant is not essential. If used, the surfactant may be added during said step d).

Even after the polar aprotic solvent is completely removed, the PBFDO micelles can still dissolve in water.

The polymerization step, i.e. step b) may occur at a temperature from 20° C. to 150° C. In particular, [AQs]- showed much stronger catalytic activity compared to TMQ. According to the second embodiment of the present invention, i.e, wherein the solvent system comprises a polar aprotic solvent, [AQs]- can catalyse the polymerization of HBFDO into PBFDO at room temperature, which is a great advantage in terms of cost-efficiency.

As mentioned above, the method of the present invention may further comprise a step of:
c′) removing the catalyst by filtration, oxidation and recycling the catalyst.

Finally, the method of the present invention may comprise additional steps, e.g. post-processing and purification steps. Such steps may also be performed in water.

The present invention further relates to a water-soluble n-type conducting polymer obtained by the method described above. The polymer may be in the form of micelles having a diameter lower than 200 nm. The particle size may easily be verified by filtration of the polymer solution through a 20 μm filter, whereupon it may be observed that the solution remains coloured, thus indicating that the polymer micelles pass through the filter.

Moreover, the present invention relates to a water-based ink comprising the water-soluble n-type conducting polymer as mentioned above.

The n-type conducting ink of the present invention may thus be spin-coated or drop-cast in air and ambient temperature, forming the film having thicknesses from 1 nm to 1 cm, more preferably from 10 nm to 10 μm. Such a film may exhibit electrical conductivity in the order of 5 S/cm.

The present invention further relates to an organic optical or electronic device comprising the n-type conducting composition described above.

As mentioned above, the n-type water-based conducting ink according to the present invention, may be used in an organic optical or electronic device, such as OECTs, thermoelectric devices, ternary logic inverters, OPVs, OLEDs, organic supercapacitors, batteries, fuel cells, sensors and memories.

### BRIEF DESCRIPTION OF THE DRAWINGS

Embodiments of the invention will now be described by way of example with reference to the accompanying drawings, of which:

FIG. 1 shows the steps of the method according to the first embodiment of the present invention;

FIG. 2 shows the steps of the method according to the second embodiment of the present invention;

FIG. 3 depicts PBFDO-water ink in concentration of 1.5 mg/ml;

FIG. 4 depicts PBFDO-water ink in concentration of 0.1 mg/ml;

FIGS. 5-6 illustrate apparent hydrodynamic diameter of the PBFDO water-based ink polymerized from DMSO-water mixed solvent with different water content.

### DETAILED DESCRIPTION OF THE INVENTION

As mentioned above, the present invention provides a method for manufacturing a water-soluble n-type conducting polymer, the method comprising the steps of:
a) adding a monomer to a solvent system comprising water in the presence of a catalyst, thus providing a reaction solution;
b) allowing the monomer to polymerize in the reaction solution thus obtaining an n-type conducting polymer solution;
c) post-treating the n-type conducting polymer solution thus obtaining a water-soluble n-type conducting polymer.

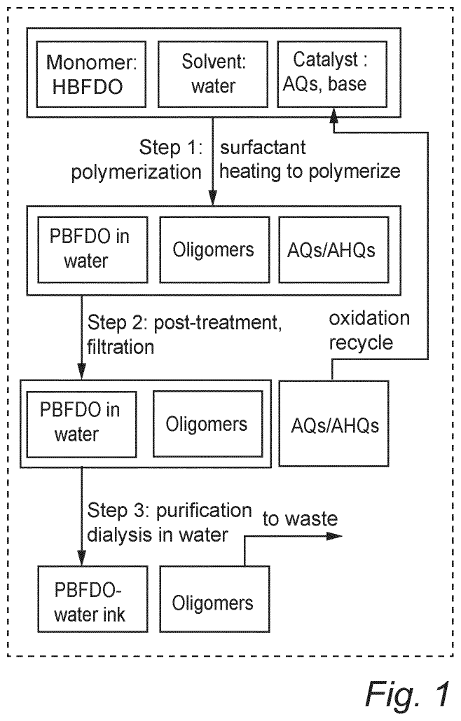

According to the first embodiment illustrated in FIG. 1, the solvent system consists of water. In other words, the solvent system comprises substantially only water, e.g. at least 99 vol % water. Such an embodiment offers the advantage of a cost-efficient and environmentally friendly manufacturing method.

As may be seen in FIG. 1, the method further comprises a step of:
a′) adding a base and a surfactant to the reaction solution.

Step a′) may occur during or immediately after step a). In other words, the base and the surfactant may be added to the reaction solution together with the monomer and the catalyst, or immediately after the addition of the monomer and the catalyst.

According to the first embodiment, the catalyst may be an alkyl- and carboxyl-substituted benzoquinone (AQ). Such a catalyst may be selected from the group consisting of 3-(2,4,5-trimethyl-3,6-dioxocyclohexa-1,4-dien-1-yl)propanoic acid (AMMMQ, R⁰=R¹=R³=Me), 3,3′-(4,5-dimethyl-3,6-dioxocyclohexa-1,4-diene-1,2-diyl)dipropionic acid (AAMMQ, R⁰=R¹=Me, R³=—CH₂R⁴R⁵COOH, R⁴, R⁵=H or Me), 3,3′-(2,5-dimethyl-3,6-dioxocyclohexa-1,4-diene-1,4-diyl)dipropionic acid (AMAMQ, R¹=R³=Me, R⁰=—CH₂R⁴R⁵COOH, R⁴, R⁵=H or Me) and combinations thereof.

The catalysts can be easily isolated, recovered, and recycled to further polymerize PBFDO, as shown in the scheme below.

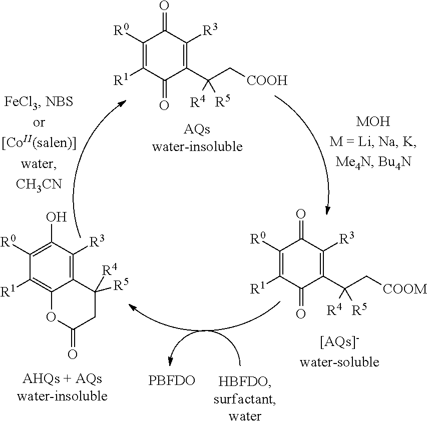

According to a particular embodiment of the present invention, the catalyst may be synthesized as follows. Methane sulfonic acid (10 mL) was heated to 70° C. in an oil bath, 2,3,5-trimethylbenzene-1,4-diol (1 g, 6.57 mmol) and tert-butyl acrylate (1.09 mL, 7.42 mmol) were added under stirring. The reaction continued at 70° C. for 90 min, then the mixture was diluted to 100 ml water and extracted with ethyl acetate 3 times. The extracts were washed with water, saturated NaHCO₃, saturated NaCl, and dried (Na₂SO₄). The solvent was removed by a rotary evaporator. The residue was purified by silica gel chromatography to afford the pure solid lactone 3MCQ (0.81 g, 60% yield). To a solution of lactone 3MCQ (1.8 g, 8.73 mmol) in 90 mL 10% aqueous acetonitrile was added dropwise of a solution of NBS (1.63 g, 9.16 mmol) in 18 mL acetonitrile. The reaction mixture was stirred for 1 hour at 25° C. and the solvent was removed by rotary evaporator. The residue was diluted with water and extracted with several portions of ether. The combined ether extracts were washed with water, brine, and dried (used Na₂SO₄). Removal of solvent and crystallization (acetone-hexane) afforded 1.5 g product AMMMQ (80% yield).

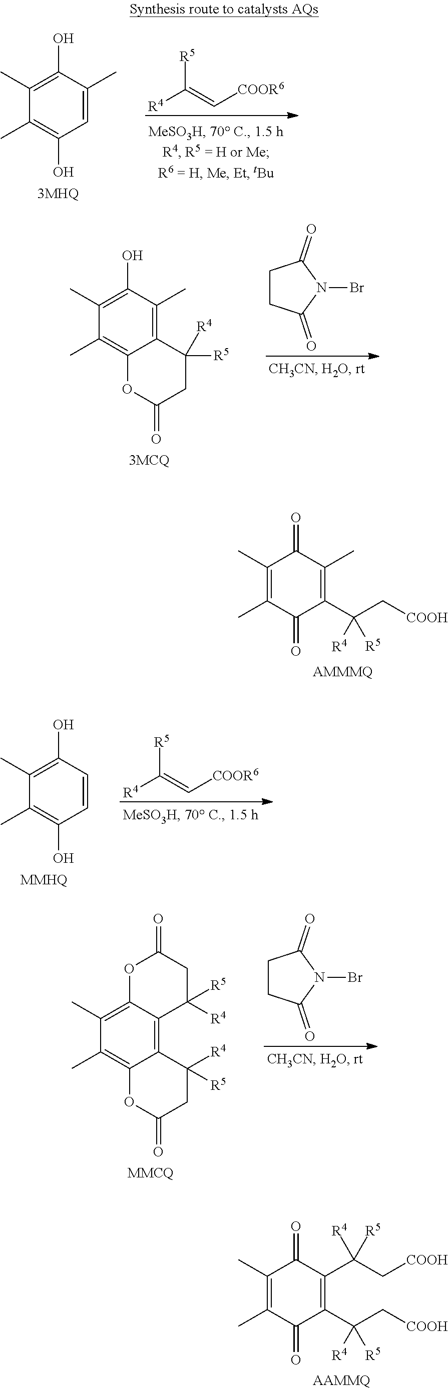

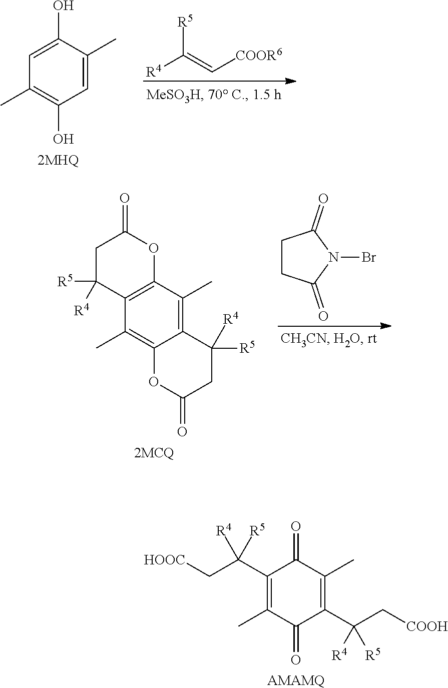

The water-soluble PBFDO micelles were synthesized as follows. To a suspension of catalyst AMMMQ (46.75 mg, 0.21 mmol) in 1.6 ml water was added NaOH (0.42 ml, 0.5 M), and the suspension became a bright yellow solution after stirring for 10 mins. Then, surfactant PDADMAC (100 mg, 0.63 mmol) and monomer HBFDO (40 mg, 0.21 mmol) were added to the reaction mixture and stirred at 100° C. overnight. The catalyst was isolated by filtration, the filtrate PBFDO-water solution was transferred to a dialysis bag, dialyzed in deionized water for 2 days to remove oligomers to obtain PBFDO-water ink. The PBFDO-water ink can be diluted or concentrated by centrifugal dialysis to 1-50 mg/mL for spin-casting, drop-casting, and other thin film processing methods.

The catalyst was recycled as follows. To the isolated AMMMQ/AMMMHQ (45 mg, 0.2 mmol 95% recovery) in 5 mL acetonitrile:H₂O (1:1) was added FeCl₃·6H₂O (215 mg, 0.8 mmol) in 1 mL H₂O solution. The reaction mixture was stirred for 10 min at room temperature and diluted with water, extracted with several portions of ether. The combined ether extracts were washed with water, brine, and dried (Na₂SO₄). Removal of solvent and crystallization (acetone-hexane) yielded 41 mg (92% yield) catalyst AMMMQ.

Using the AQs as described above, the inventors have provided the world's first example of an n-type conducting polymer polymerizing in pure water. According to the method of the present invention, a PBFDO water-based ink having micelle particle size of 120 nm has been manufactured. The PBFDO-water ink with similar excellent solution-processability can be spin-casted and drop-casted in air to obtain thin film conductivity over 50 S/cm.

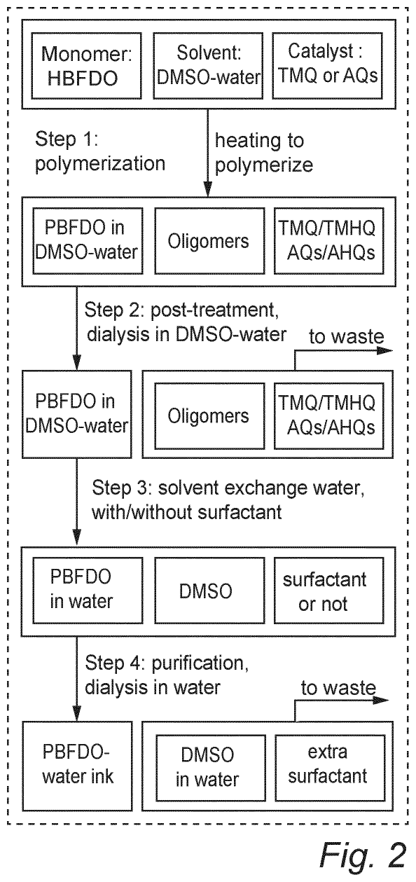

FIG. 2 depicts the method of the present invention according to the second embodiment. As mentioned above, according to this embodiment, the solvent system may comprise a polar aprotic solvent. In such an embodiment, the method further comprises the step of:
d) solvent exchanging such that the polar aprotic solvent is removed.

The polar aprotic solvent may be dimethyl sulfoxide (DMSO), dimethyl formamide (DMF), dimethyl acetamide (DMA) or a combination thereof. The ratio between water and the polar aprotic solvent may be from 5:95 to 95:5, preferably from 40:60 to 60:40.

According to the second embodiment of the present invention, i.e, wherein the solvent system comprises a polar aprotic solvent, the catalyst may be a quinone oxidant selected from tetramethyl benzoquinone (TMQ), alkyl- and carboxyl-substituted benzoquinones (AQs), or combination thereof.

The inventors have surprisingly found that performing the polymerization reaction in a solvent system comprising water and a polar aprotic solvent promotes the formation of water-soluble PBFDO micelles, that may be further stabilized by addition of a surfactant, e.g. as disclosed above. It should be noted that according to the second embodiment of the present invention, the surfactant is not essential. If used, the surfactant may be added during said step d).

Even after the polar aprotic solvent is completely removed, the PBFDO micelles can still dissolve in water.

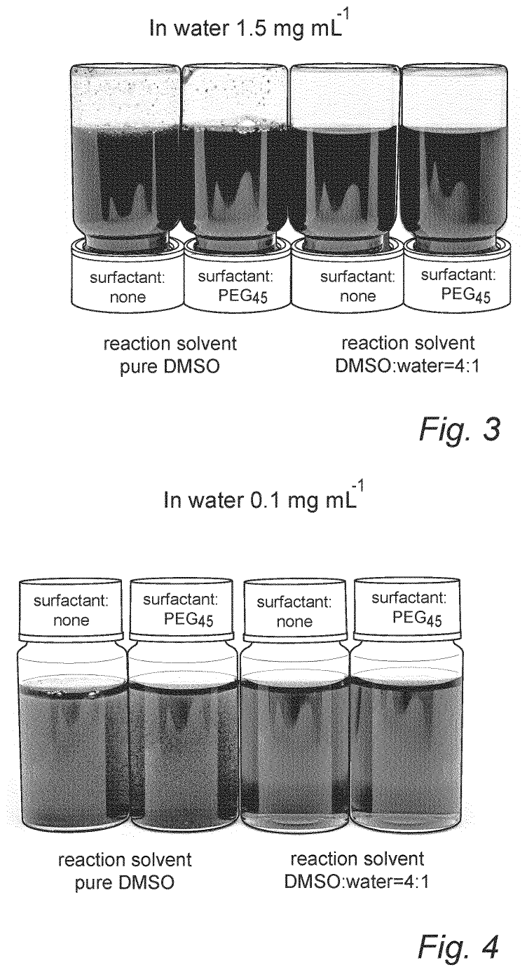

The PBFDO polymerized through DMSO:water mixed solvent is soluble in water. After removing the catalyst and DMSO, this PBFDO still shows excellent solubility in water. On the contrary, PBFDO polymerized through pure DMSO is insoluble in water, even with surfactant, as is illustrated in FIGS. 3 and 4. FIGS. 3 and 4 are photographs of PBFDO-water ink in different concentrations. Thus, FIG. 3 depicts PBFDO-water ink in the concentration of 1.5 mg/mL, and FIG. 4 illustrates PBFDO-water ink in the concentration of 0.1 mg/mL. The polymer PBFDO obtained through polymerization reaction in pure DMSO is insoluble in water, even with surfactant PEG₄₅, while PBFDO obtained through polymerization reaction in DMSO:water=4:1 shows excellent solubility in water.

Dynamic light scattering results show that the PBFDO polymerized in pure DMSO shows a micelle particle size of 12 μm in water. With DMSO:water mixed solvent for polymerization reaction, the PBFDO micelle particle size can be dramatically reduced to below 100 nm, wherein the water content is from 15 vol % to 50 vol %. These results imply that the solvent system used in the method of the present invention for PBFDO polymerization can reduce PBFDO micelle particle size 120-240 times, and make PBFDO micelles soluble in water. Further, using the solvent system as described above an environmentally friendly PBFDO-water ink with excellent solution-processability was developed. Such an ink can be spin-casted and drop-casted in air to obtain thin films. The spin-casted PBFDO thin film shows high electrical conductivity over 100 S/cm and excellent air stability.

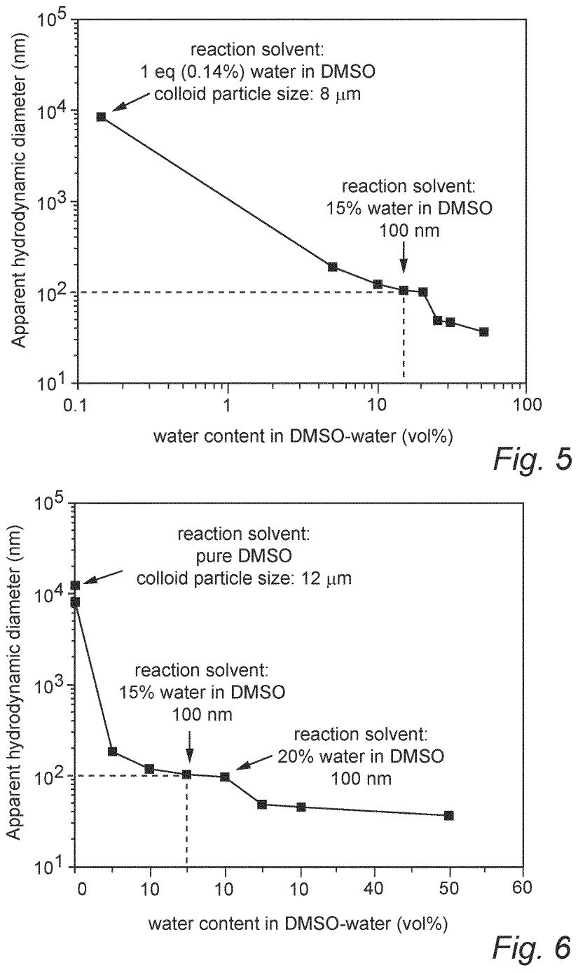

FIGS. 5 and 6 illustrate apparent hydrodynamic diameter of the PBFDO water-based ink polymerized from DMSO-water mixed solvent with different water content. The method of the present invention reduces the micelle particle size of PBFDO 50-100 times, which makes PBFDO micelles water-soluble and water-processable.

The polymerization step, i.e. step b) may occur at a temperature from 20° C. to 150° C. In particular, [AQs]- showed much stronger catalytic activity compared to TMQ. According to the second embodiment of the present invention, i.e, wherein the solvent system comprises a polar aprotic solvent, [AQs]- can catalyse the polymerization of HBFDO into PBFDO at room temperature, which is a great advantage in terms of cost-efficiency.

As mentioned above, the method of the present invention may further comprise a step of:
c′) removing the catalyst by filtration, oxidation and recycling the catalyst.

Finally, the method of the present invention may comprise additional steps, e.g. post-processing and purification steps. Such steps may also be performed in water.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention.

1. A method for manufacturing a water-soluble n-type conducting polymer, said method comprising the steps of:
a) adding a monomer to a solvent system comprising water in the presence of a catalyst, thus providing a reaction solution;
b) allowing said monomer to polymerize in said reaction solution thus obtaining an n-type conducting polymer solution;
c) post-treating said n-type conducting polymer solution thus obtaining a water-soluble n-type conducting polymer.

2. A method according to claim 1, wherein said solvent system consists of water, and wherein said method further comprises a step of:
a′) adding a base to said reaction solution,
wherein step a′) occurs during or immediately after step a).

3. The method according to claim 2, wherein said catalyst is an alkyl- and carboxyl-substituted benzoquinone (AQ).

4. The method according to claim 2 or 3, wherein said base is MOH, wherein M is selected from Li⁺, Na⁺, K⁺, Me₄N⁺, Bu₄N⁺ or combination thereof.

5. The method according to any one of claims 2-4, said method further comprising a step of:
a″) adding a surfactant to said reaction solution,
wherein step a″) occurs immediately before, during or immediately after step a′).

6. The method according to claim 1, wherein said solvent system further comprises a polar aprotic solvent, and wherein said method further comprises the step of:
d) solvent exchanging such that said polar aprotic solvent is removed.

7. The method according to claim 6, wherein said catalyst is quinone oxidant selected from tetramethyl benzoquinone (TMQ), alkyl- and carboxyl-substituted benzoquinones (AQ), or combination thereof.

8. The method according to claim 6 or 7, wherein said polar aprotic solvent is dimethyl sulfoxide (DMSO), dimethyl formamide (DMF), dimethyl acetamide (DMA) or a combination thereof.

9. The method according to any one of claims 6-8, wherein the ratio between water and said polar aprotic solvent is from 5:95 to 95:5.

10. The method according to any one of claims 6-9, wherein a surfactant is added during said step d).

11. The method according to any one of the preceding claims, wherein said step b) occurs at a temperature from 20° C. to 150° C.

12. The method according to any one of the preceding claims, wherein said monomer is 3,7-dihydrobenzo[1,2-b:4,5-b]difuran-2,6-dione (HBFDO), and wherein said n-type conducting polymer is poly(benzodifurandione) (PBFDO).

13. The method according to any one of the preceding claims, wherein said method further comprises a step of:
c′) removing said catalyst by filtration, oxidation and recycling said catalyst.

14. A water-soluble n-type conducting polymer obtained by the method according to any one of claims 1-13, wherein said polymer is in the form of micelles having a diameter lower than 200 nm.

15. A water-based ink comprising the water-soluble n-type conducting polymer according to claim 14.
